(19) United States
(12) Patent Application Publication
(10) Pub. No.: US 2014/0032882 A1
(43) Pub. Date: Jan. 30, 2014

(54) MODIFICATION OF FUNCTIONALITY IN EXECUTABLE CODE

(71) Applicants: Les G. Woolsey, Ottawa (CA); Ken Beaton, Ottawa (CA)

(72) Inventors: Les G. Woolsey, Ottawa (CA); Ken Beaton, Ottawa (CA)

(73) Assignee: Adobe Systems Incorporated

(21) Appl. No.: 11/777,460

(22) Filed: Jul. 13, 2007

(51) Int. Cl. G06F 9/30

(52) U.S. Cl. 712/226; 712/E09.028

(57) ABSTRACT

In an example embodiment, an instruction set is accessed. An instruction modifier is associated with the instruction set. Thereafter, the instruction set is transformed into a modified instruction set based on the instruction modifier. After the transformation, the modified instruction set is executed.

### FIELD

The present disclosure relates generally to computer software and, in an example embodiment, the disclosure relates to the modification of functionality in executable code.

### BACKGROUND

A software application may be updated to modify existing functionality and/or to provide additional functionality. For example, enterprise application software may need to be updated to support new document templates. In another example, a server application may need to be updated to fix problems with existing functionality.

To update a software application, a programmer needs to modify and recompile the existing source code. The source code is recompiled into an executable code (e.g., binary file) that may be applied as a patch to the existing executable code. The patch may modify or completely replace the existing executable code.

The application of a patch requires that the software application to be shut down. After the patch is applied, the software application typically needs to be reinitialized. A shutdown of certain applications, especially server applications, may not be practical because such applications are accessed 24 hours a day. Additionally, shutting down a software application used by a business for any duration of time may result in a shutdown of the business. Furthermore, the existing executable code associated with the software application may also be obsolete and not supported. Accordingly, a modification of the existing source code may not be possible.

### BRIEF DESCRIPTION OF DRAWINGS

The present disclosure is illustrated by way of example and not limitation in the figures of the accompanying drawings, in which like references indicate similar elements and in which:

FIG. 1 is a diagram of an example embodiment of a networked system;

FIG. 2 is a simplified block diagram of an example embodiment of modules that may be included in an apparatus;

FIG. 3 is a flow diagram of a general overview of a method, in accordance with an example embodiment, for modifing a functionality;

FIG. 4 is a diagram of detailed operations, in accordance with an example embodiment, for transforming an instruction set;

FIG. 5 is a diagram of detailed operations, in accordance with an example embodiment, for executing a modified instruction set;

FIG. 6 is a flow diagram of a general overview of a method, in accordance with another example embodiment, for modifying a functionality;

FIG. 7 is a diagram of detailed operations, in accordance with another example embodiment, for transforming an instruction set;

FIG. 8 is a diagram of detailed operations, in accordance with another example embodiment, for executing a modified instruction set; and

FIG. 9 is a simplified block diagram of an example embodiment of a representation of a machine in the example form of a computer system.

### DESCRIPTION OF EXAMPLE EMBODIMENTS

In the following description, for purposes of explanation, numerous specific details are set forth in order to provide a thorough understanding of an example embodiment of the present disclosure. It will be evident, however, to one skilled in the art that the present disclosure may be practiced without these specific details.

### OVERVIEW

The embodiments described herein provide methods and systems for modifing functionally in executable code. To update the existing functionality provided by a software application system, a user (e.g., a programmer) may add a modifing executable code to the software application system. The modifing executable code provides, for example, additional functionalities when executed. As explained in more detail below, a variety of transformations may be used to modify or update instruction sets to call the modifying executable code. For example, transformation operations may be applied to instructions sets that are associated with the existing functionality to call the modifying executable code.

### EXAMPLE EMBODIMENTS

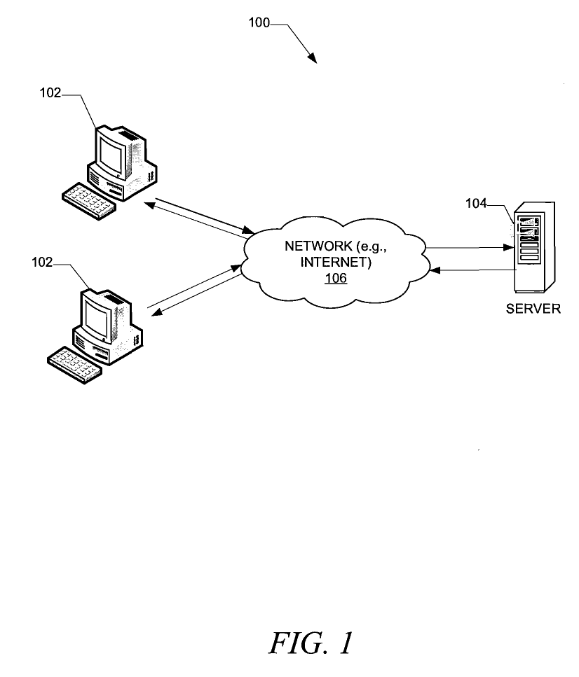

FIG. 1 is a diagram of an example embodiment of a networked system. Example system 100 includes various computing devices 102 and 104 in communication by way of network 106 which may include one or more Local Area Networks (LANs) and/or Wide Area Networks (WANs), such as the Internet. Computing devices 102 and 104 may include a variety of computing devices. For example, the computing device can include a computer system based on a processing unit and a memory, a portable computing device, a personal digital assistant, a computational engine within an appliance, and other computing devices. As shown in FIG. 1, system 100 includes client computing devices 102 and server 104. Server 104 can provide server-side functionalities (e.g., services and tasks), by way of network 106, to one or more clients, such as client computing devices 102. In turn, client computing devices 102 can directly or indirectly rely on server 104 for information and application tasks. Functionalities may include, for example, generating forms or documents, digital certification of forms, maintaining security policies for forms, serving forms, verifying the source of the forms, serving contents, searching for contents, setting valid data ranges, restricting access to data fields, setting up Web services connections, and other functionalities. Examples of server 104 include an application server, a mail server, a Web server, a database server, and other servers.

Server 104 may host a variety of executable codes that, when executed, provide the functionalities. As explained in more detail below, server 104 may additionally include an extendable application programming interface (API) that is configured to modify the functionalities without modifying the executable code itself. It should be noted that while system 100 shown in FIG. 1 employs a client-server architecture, the present disclosure is not limited to such an architecture, and could equally well find application in a distributed, or peer-to-peer, architecture system. Another embodiment may, for example, be implemented as a stand-alone application (e.g., without any network capabilities).

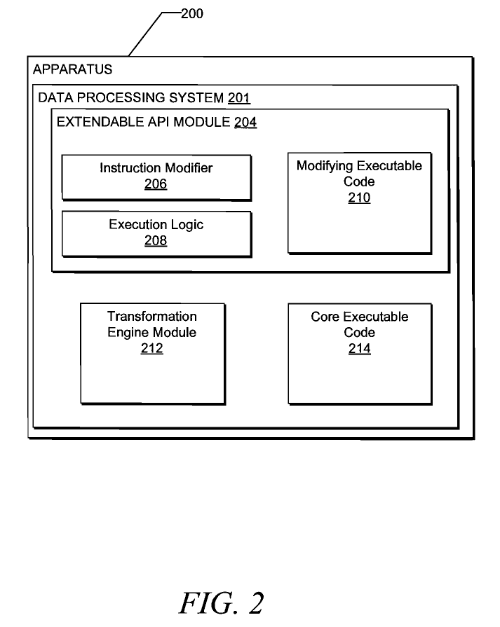

FIG. 2 is a simplified block diagram of an example embodiment of modules that may be included in an apparatus. An example of apparatus 200 may include a variety of computing devices, such as server 104 depicted in FIG. 1. In various example embodiments, apparatus 200 may be used to implement computer programs, logic, applications, methods, processes, or other software. Apparatus 200 may host data processing system 201. As shown in the example embodiment of FIG. 2, data processing system 201 may include extendable API module 204, transformation engine module 212, and core executable code 214. When executed or called by an instruction, core executable code 214 provides various functionalities. Extendable API module 204 and transformation engine module 212 together can modify the functionalities without modifying core executable code 214. Modification can include the addition, deletion, and/or modification of the functionalities.

Extendable API module 204 may include modifying executable code 210, instruction modifier 206, and execution logic 208. When executed, modifing executable code 210 is configured to provide functionalities that modify the existing functionalities provided by core executable code 214. Examples of modifying executable code 210 include bytecode, machine code (e.g., binary code), object code (e.g., object file), and other executable codes. In an example embodiment, modifying executable code 210 may be included in a Java Archive (JAR) file, which is a collection of Java classes.

Instruction modifier 206 includes the transformation instructions provided to transformation engine module 212 to carry out a transformation operation on an instruction set. Transformation instructions may include various transformation commands, such as transformation commands associated with adding an instruction to an instruction set, deleting an instruction from an instruction set, replacing an instruction included within an instruction set, modifying an instruction included within an instruction set, and other transformation commands. Transformation commands may be in a variety of transformation languages. The extensible Stylesheet Language (XSL) may be an example transformation language, which is an extensible Markup Language (XML) based language. XSL may include extensible Stylesheet Language Transformations (XSLT), which is an XML language used for the transformation of XML documents. Another example transformation language may include XQuery, which is a query language that is designed to query collections of XML data. Other transformation languages include Streaming Transformations for XML (STX), XPath, and Xtatic. Furthermore, transformation instructions may include the data to be used in the transformation operations. As explained in more detail below, examples of data may include instruction sets, modifier identifiers that are configured to identify other instruction modifiers, and other data.

Transformation engine module 212 is configured to transform an instruction set based on instruction modifier 206. Transformation engine module 212 can perform a variety of transformation operations. Various example embodiments of transformation operations include adding one or more instructions to one or more instruction sets (e.g., merge operation), deleting one or more instructions from one or more instruction sets, replacing one or more instructions included in one or more instruction sets, and modifying one or more instructions in one or more instruction sets. Examples of transformation engine module 212 include XSL/XSLT transformation engines, XQuery engines, Java Transformer API, Simple API for XML (SAX) parser, Document Object Model (DOM) processing set, and other transformation engine modules.

Still referring to FIG. 2, extendable API module 204, in accordance with an example embodiment, may include execution logic 208. Execution logic 208 includes logic that defines an execution order. As explained in more detail below, instructions may be executed in a particular order and execution logic 208 defines the execution order.

It should be appreciated that apparatus 200 may be dedicated for hosting data processing system 201. Alternatively, data processing system 201 may be adapted to run on a distributed execution environment where multiple apparatuses, such as servers, may execute one or more portions of the data processing system. For example, data processing system 201 may be executed in a distributed fashion on separate apparatuses. It should also be noted that in other embodiments, data processing system 201 may include fewer, more, or different modules apart from those shown in FIG. 2. In an example embodiment, data processing system 201 may include multiple extendable API modules. In another example embodiment, data processing system 201 may not include execution logic 208 because an order of execution is not defined.

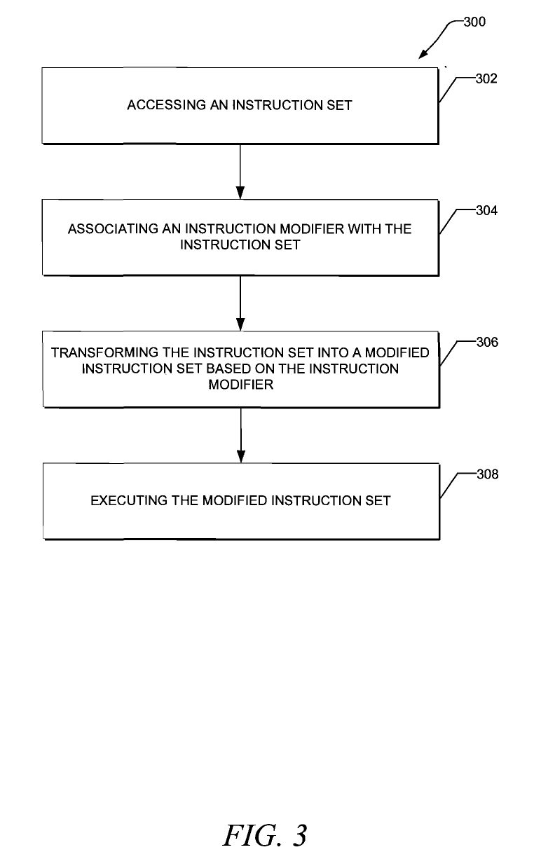

FIG. 3 is a flow diagram of a general overview of a method, in accordance with an example embodiment, for modifying a functionality. In an example embodiment, method 300 may be implemented by data processing system 201 of FIG. 2, employed in an apparatus, such as server 104 of FIG. 1. As shown in FIG. 3, in an example embodiment, an instruction set is accessed at 302. An instruction set includes one or more instructions. An instruction may specify the functionality (or operation) to be performed. An instruction may also include the data for use with the instruction. An instruction set may, for example, be based on XML, Java, or other languages. It should be noted that the instructions within an instruction set may be organized in a variety of structures. For example, an instruction set may be organized in a hierarchical structure that includes instructions with various child instructions (or sub-instructions). Further, in an example embodiment, the instruction set may include modifier identifiers, which are explained in more detail below. The instruction set may be included in various contents. In an example embodiment, the instruction set may be included in a document or a form, such as a Portable Document Format (PDF) document, an XML document, or other documents. In another example embodiment, the instruction set may be included in a file, such as an XML file or an XML Data Package (XDP) file. It should be appreciated that an XDP file may include XML form data, XML form templates, PDF documents, and other XML information. It should be appreciated that there are a variety of methods to access the instruction set. For example, instruction set may be stored on an apparatus and access may include locating and loading the instruction set. In another example, access may include receiving the instruction set from another apparatus (e.g., a client computing device). In still another example, access may include retrieving the instruction set from another apparatus.

At 304, one or more instruction modifiers may be associated with the instruction set. As discussed above, an instruction modifier includes the transformation instructions provided to a transformation engine module to carry out a transformation operation on the instruction set. The instruction modifier therefore provides the transformation instructions to modify the instruction set. In an example embodiment, a user may select an instruction modifier to be associated with the instruction set. In another example embodiment, the association may be based on a mapping of associations. The mapping can include information on the correspondence between various instructions and their associated instruction modifiers. For example, the mapping may include information that links an Instruction A with an Instruction Modifier A. The mapping may be stored in a variety of data structures, such as a table, a database, a file, and other data structures, which may be included in the extendable API module.

At 306, the first instruction set then is transformed based on the instruction modifier into a modified instruction set. Example embodiments of transformation operations may include deleting one or more instructions from the instruction set, adding one or more instructions to the instruction set, replacing one or more instructions included in the instruction set, modifying one or more instructions from the instruction set, and other transformation operations. The modified instruction set therefore is a modification of the instruction set.

At 308, the modified instruction set is executed. The instruction can call or reference an executable code and execution of the modified instruction may include, for example, retrieving an executable code associated with an instruction. In an example embodiment, the modified instruction set may include instructions that call the modifying executable code instead of the core executable code. After the executable code is retrieved, the executable code is executed. It should be appreciated that execution can include the loading and interpreting of executable code. If the modifying executable code is executed, then the modifying executable code modifies the existing functionality, which is originally provided by the core executable code.

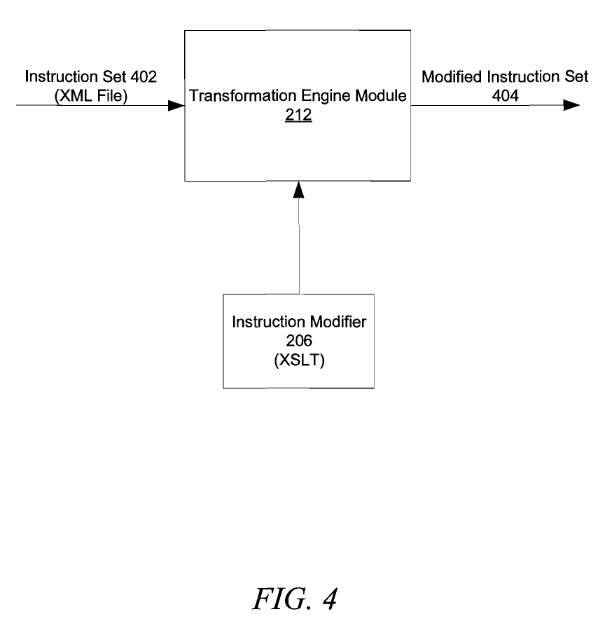

FIG. 4 is a diagram of detailed operations, in accordance with an example embodiment, for transforming an instruction set. As shown in FIG. 4, transformation engine module 212 accesses instruction set 402. In this example embodiment, instruction set 402 is included in an XML file. Instruction set 402 is associated with instruction modifier 206. Here, the transformation language used by instruction modifier 206 includes XSLT, which is used for the transformation of XML documents (or files). It should be appreciated that a data processing system may include multiple instruction modifiers and, in an example embodiment, the choices of instruction modifiers may be provided to a user. The user may select one or more instruction modifiers, such as instruction modifier 206, to be applied to a particular instruction set, such as instruction set 402. A user may therefore experiment with various types of instruction modifiers to be applied to instruction set 402. In another example embodiment, a mapping may be used to identify the association of instruction modifier 206 with instruction set 402. Once the instruction modifier 206 is identified from the mapping, the instruction modifier may be automatically applied to instruction set 402.

Transformation engine module 212 accesses instruction set 402 and the transformation engine module is configured to transform the instruction set into modified instruction set 404. In an example embodiment, transformation engine module 212 may additionally be configured to output log information. Log information is information associated with the transformation. In an example, the log information is the change to instruction set 402. After each individual transform operation, instruction set 402 is analyzed for change. If a change is detected, log information of the change is generated. In an example embodiment, transformation engine module 212 may output log information in modified instruction set 404. In another example embodiment, transformation engine module 212 may output the log information to a separate file.

It should be noted that, in example embodiments, multiple transformations may be applied to instruction set 402. Here, multiple instruction modifiers, such as instruction modifier 206, may be associated with instruction set 402. Each instruction modifier may call one or more transformation engine modules, such as transformation engine module 212. In FIG. 4, for example, modified instruction set 404 may be accessed by another transformation engine module (not shown) for a second transformation operation. If log information is included in modified instruction set 404, the log information may be removed from the modified instruction set before being accessed by another transformation engine module.

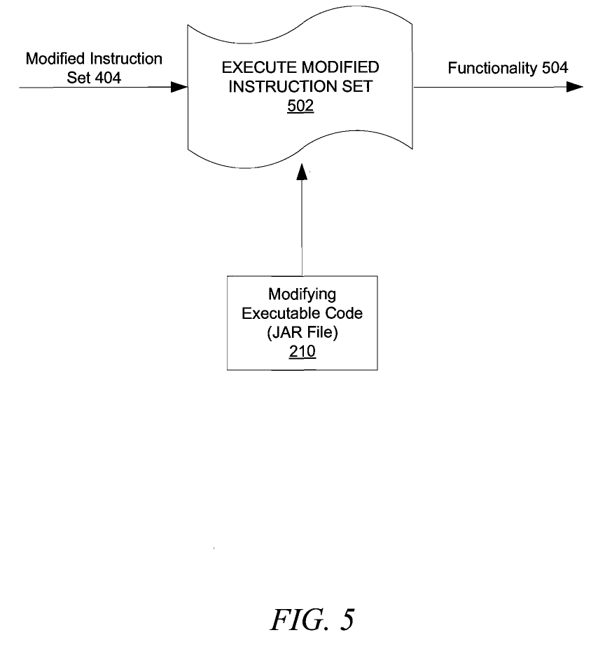

FIG. 5 is a diagram of detailed operations, in accordance with an example embodiment, for executing a modified instruction set. After the transformation of an instruction set into modified instruction set 404, the modified instruction set is executed at 502. A data processing system includes core executable code. If a user wants to modify the functionality of the core executable code, the user may create and add modifying executable code 210. For example, the user may create modifying executable code 210 in a Java Archive (JAR) file, which includes Java classes and associated metadata. The user may then place or copy the JAR file (or modifying executable code 210) in a folder where the data processing system is configured to load the JAVA classes at runtime.

In an example embodiment, modified instruction set 404 may include instructions that are associated with modifying executable code 210. For example, when modified instruction set 404 is executed at 502, instructions included in the modified instruction set may call modifying executable code 210 (as well as the core executable code). When called, modifying executable code 210 is retrieved and executed. As a result of the execution of modifying executable code 210, functionality 504 is provided that modifies the existing functionality.

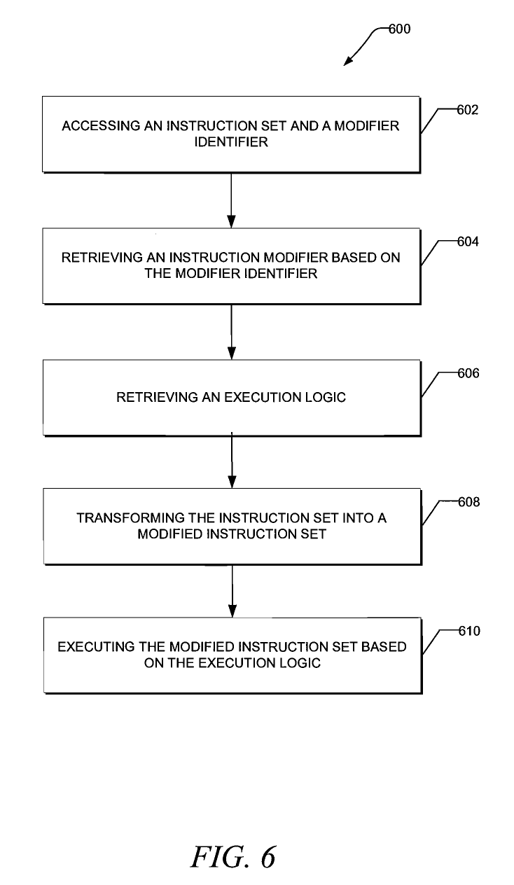

FIG. 6 is a flow diagram of a general overview of a method, in accordance with another example embodiment, for modifying a functionality. In an example embodiment, method 600 may be implemented by data processing system 201 of FIG. 2, employed in an apparatus, such as server 104 of FIG. 1. As shown in FIG. 6, in an example embodiment, an instruction set is accessed at 602. A modifier identifier may also be accessed at 602, in accordance with an example embodiment. A modifier identifier is data that is configured to identify one or more instruction modifiers. In an example, the modifier identifier may be a pointer to an address location of an instruction modifier. In another example, the modifier identifier may be a filename of an instruction modifier. In still another example, the modifier identifier may be a table index or database index associated with an instruction modifier.

After the instruction set and the modifier identifier are accessed, one or more instruction modifiers may be retrieved at 604 based on the modifier identifier. The modifier identifier is configured to identify one or more instruction modifiers. Accordingly, the modifier identifier may be used to locate an instruction modifier. After the instruction modifier is located, the instruction modifier is retrieved.

In addition to retrieving the instruction modifier, execution logic may also be retrieved at 606, in accordance with an example embodiment. It should be appreciated that instructions may be executed or processed in certain order or steps. The execution logic defines the execution order of the instructions. A variety of execution orders may be included in the execution logic. For example, the execution logic may define the execution of instructions in a sequential order. In an example, execution logic may define that Instruction A is to be executed after Instruction B. In another example, execution logic may define that Instruction A cannot be executed after Instruction B. In still another example, execution logic may define that Instruction X cannot be executed without Instruction A being executed unless Instruction B is present. The execution logic may also define the execution of instructions in parallel.

At 608, the instruction set then is transformed based on the retrieved instruction modifier into a modified instruction set. At 610, the modified instruction set is executed based on the execution logic. Here, for example, the modified instruction set may include multiple instructions and the execution logic defines the execution order of the instructions. The instructions can call the modifying executable code and/or the core executable code. If the modifying executable code is executed, then the modifying executable code modifies the existing functionalities that are originally provided by the core executable code.

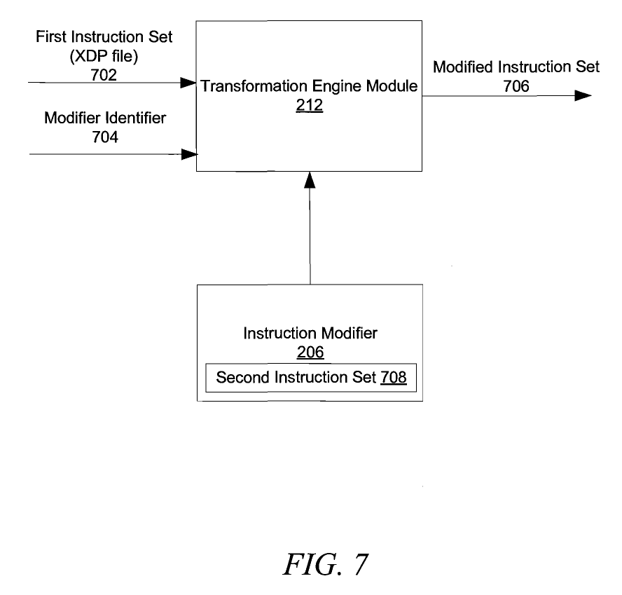

FIG. 7 is a diagram of detailed operations, in accordance with another example embodiment, for transforming an instruction set. As shown in FIG. 7, first instruction set 702 and modifier identifier 704 are accessed by transformation engine module 212. In this example embodiment, first instruction set 702 is included in an XDP file. It should be appreciated that first instruction set 702 and modifier identifier 704 may be received from a client computing device. At a client computing device, a user may select instruction modifier 206 to be associated with first instruction set 702. Instruction modifier 206 may not be stored in the client computing device. To access instruction modifier 206, the client computing device transmits modifier identifier 704 that identifies the instruction modifier to, for example, an application server that hosts the instruction modifier. Alternatively, the client computing device may automatically associate modifier identifier 704 with first instruction set 702. Modifier identifier 704 may be included with or attached to first instruction set 702. In another example, modifier identifier 704 may be received separately from first instruction set 702.

After first instruction set 702 and modifier identifier 704 are received, instruction modifier 206 is retrieved based on the modifier identifier. In this example embodiment, modifier identifier 704 is configured to identify instruction modifier 206. For example, modifier identifier 704 may include the filename of instruction modifier 206. A data processing system may search for the filename within the extendable API module. Once instruction modifier 206 with the filename is located, the instruction modifier is loaded or retrieved.

In the example embodiment of FIG. 7, instruction modifier 206 may include second instruction set 708. First instruction set 702 may call the core executable code included in the data processing system. Unlike first instruction set 702, second instruction set 708 may call a modifying executable code that, when executed, modifies the functionality provided by the core executable code. Instruction modifier 206 is loaded into transformation engine module 212. Transformation engine module 212 then transforms first instruction set 702 into modified instruction set 706 based on instruction modifier 206. In the example embodiment of FIG. 7, the transformation may be a merge operation where transformation engine module 212 is configured to merge first instruction set 702 with second instruction set 708 to provide modified instruction set 706. As a result of the merge operation (or transformation), modified instruction set 706 includes first instruction set 702 and second instruction set 708.

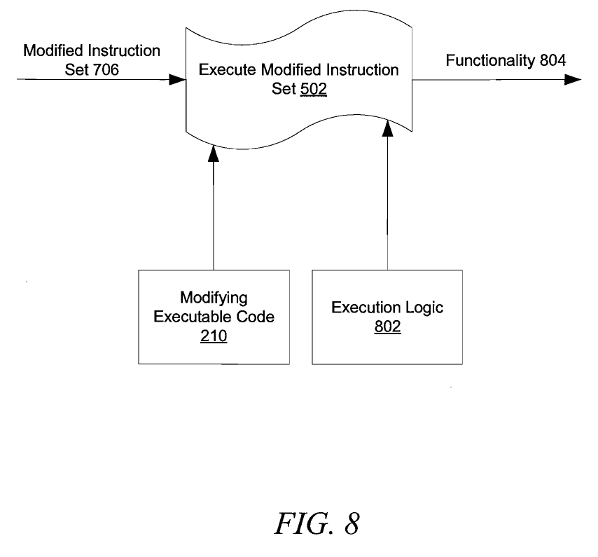

FIG. 8 is a diagram of detailed operations, in accordance with another example embodiment, for executing a modified instruction set. After the transformation of an instruction set into modified instruction set 706, the modified instruction set is executed at 502. In addition to core executable code (not shown), data processing system may also include modifing executable code 210. Modified instruction set 706 may include instructions that are associated with modifying executable code 210. For example, when modified instruction set 706 is executed at 502, instructions included in the modified instruction set may call modifying executable code 210 (as well as the core executable code). When called, modifing executable code 210 thereafter is retrieved and executed.

In an example embodiment, modified instruction set 706 may be executed at 502 based on execution logic 802. Execution logic 802 includes the execution order of instructions. Here, execution logic 802 is retrieved before or during execution of modified instruction set 706. As a result of executing 502 modifing executable code 210, functionality 804 is provided that modifies the functionality of the core executable code.

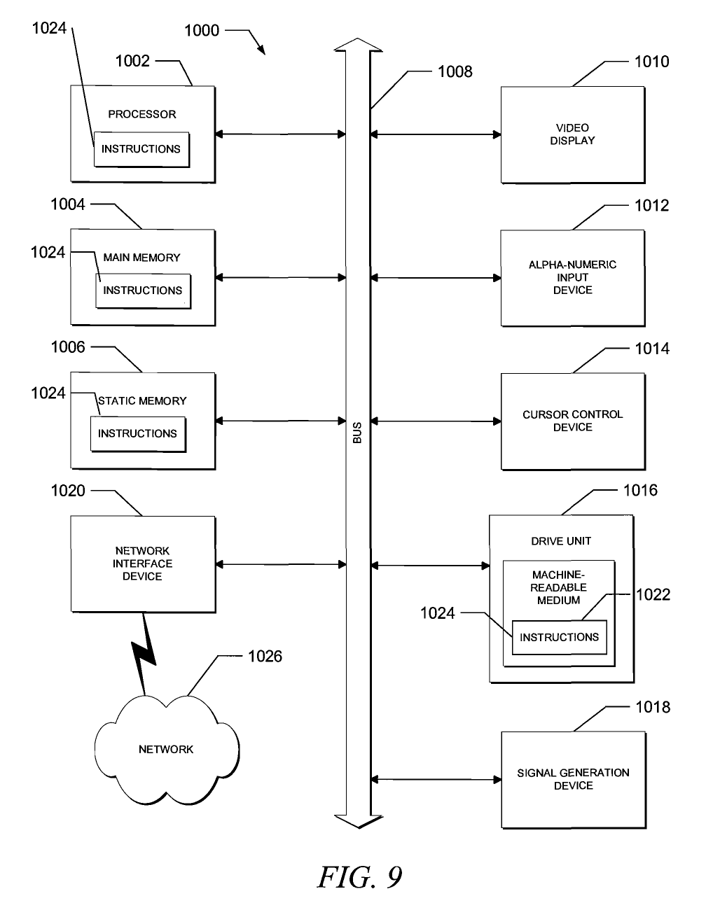

FIG. 9 is a simplified block diagram of a machine in the example form of computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes processor 1002 (e.g., a central processing unit (CPU)), main memory 1004 and static memory 1006, which communicate with each other via bus 1008. Computer system 1000 may further include a graphics processing unit (GPU), video display unit 1010 (e.g., a plasma display, a liquid crystal display (LCD) or a cathode ray tube (CRT)). Computer system 1000 may also include alphanumeric input device 1012 (e.g., a keyboard), user interface (UI) navigation device 1014 (e.g., a mouse), disk drive unit 1016, signal generation device 1018 (e.g., a speaker) and network interface device 1020.

Disk drive unit 1016 includes machine-readable medium 1022 on which is stored one or more sets of instructions and data structures (e.g., software 1024) embodying or utilized by any one or more of the methodologies or functions described herein. Software 1024 may also reside, completely or at least partially, within main memory 1004 and/or within processor 1002 during execution thereof by computer system 1000, main memory 1004 and processor 1002 also constituting machine-readable, tangible media.

Software 1024 may further be transmitted or received over network 1026 via network interface device 1020 utilizing any one of a number of well-known transfer protocols (e.g., HTTP).

While machine-readable medium 1022 is shown in an example embodiment to be a single medium, the term “machine-readable medium” should be taken to include any tangible single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present application, or that is capable of storing, encoding or carrying data structures utilized by or associated with such a set of instructions. The term “machine-readable medium” shall accordingly be taken to include, but not be limited to, solid-state memories, optical or magnetic media.

The software may also be transmitted over a network using a transmission medium. The term “transmission medium” shall be taken to include any intangible medium that is capable of storing, encoding or carrying instructions for execution by the machine. Examples include digital or analog communications signal or other intangible medium to facilitate communication of software.

Certain embodiments are described herein as including logic or a number of modules, components or mechanisms. Logic, or a module, component or a mechanism (hereinafter “modules”) may be a tangible unit capable of performing certain operations and/or being configured or arranged in a certain manner. Modules may include hardware circuitry, optical components, single or multi-processor circuits, memory circuits, circuitry or logic had temporarily configured by software program modules and objects, firmware, and combinations thereof, as appropriate for particular implementations of various embodiments.

In example embodiments, one or more computer systems (e.g., a standalone, client or server computer system) or one or more components of a computer system (e.g., a processor or a group of processors) may be configured by software (e.g., an application or application portion) as a “module” that performs certain operations as described herein. In various embodiments, a “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations.

It will be appreciated that the decision to implement a module mechanically, in dedicated and permanently configured circuitry, or in temporarily configured circuitry (e.g., configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which modules or components are temporarily configured (e.g. programmed), each of the modules or components need not be configured at any one instance in time. For example, where the modules or components comprise a general-purpose processor configured using software, the general-purpose processor may be configured as respective different modules at different times. Software may accordingly configure a processor to constitute a particular module at one instance of time and to constitute a different module at a different instance of time.

Modules can provide information to, and receive information from, other modules. Accordingly, the described modules may be regarded as being communicatively coupled. Modules may also initiate communication with input or output devices, and can operate on a resource (e.g., a collection of information).

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
accessing an instruction set that includes instructions calling an executable code of a software application system, the executable code providing an existing functionality of the software application system;
associating an instruction modifier with the instruction set, the instruction modifier including a transformation instruction to carry out a transformation operation on the instruction set to provide an additional functionality;
transforming the instruction set into a modified instruction set based on carrying out the transformation operation on the instruction set, the modified instruction set including different instructions calling a modifying executable code that provides a functionality, the functionality modifying the existing functionality to provide the additional functionality when the modified instruction set is executed, wherein the transforming of the instruction set comprises at least one of adding an instruction to the instruction set, deleting an instruction from the instruction set, and modifying an instruction included in the instruction set; and
executing the modified instruction set, the execution comprising retrieving the modifying executable code called by the different instructions and executing the modifying executable code, the executing of the modified instruction set providing the additional functionality.

2. The method of claim 1, further comprising accessing a modifier identifier that identifies the instruction modifier, wherein the associating of the instruction modifier with the instruction set comprises retrieving the instruction modifier based on the modifier identifier.

3. The method of claim 1, further comprising retrieving execution logic that defines an execution order, wherein the modified instruction set is executed based on the execution logic.

4-5. (canceled)

6. A machine-readable medium comprising instructions, which when implemented by one or more processors perform the following operations:
receiving a first instruction set and a first modifier identifier, the first modifier identifier being configured to identify a first instruction modifier, the first instruction set includes instructions calling an executable code of a software application system that provides an existing functionality of the software application system;
retrieving the first instruction modifier based on the first modifier identifier;
transforming the first instruction set into a modified instruction set based on the first instruction modifier, the modified instruction set including different instructions calling a modifying executable code that provides a functionality, the functionality modifying the existing functionality and providing an additional functionality, wherein the transforming of the instruction set comprises at least one of adding an instruction to the instruction set, deleting an instruction from the instruction set, and modifying an instruction included in the instruction set; and
executing the modified instruction set, the execution comprising retrieving the modifying executable code called by the different instructions and executing the modifying executable code, the executing of the modified instruction set providing the additional functionality.

7. The machine-readable medium of claim 6, further comprising retrieving execution logic that defines an execution order, wherein the modified instruction set is executed based on the execution logic.

8. (canceled)

9. The machine-readable medium of claim 6, wherein the first instruction modifier includes a second instruction set.

10. The machine-readable medium of claim 6, wherein the first instruction modifier includes a second modifier identifier.

11. The machine-readable medium of claim 10, wherein the second modifier identifier is configured to identify a second instruction modifier.

12. (canceled)

13. A system comprising:
an extendable application programming interface (API) module configured to:
receive a first instruction set and a modifier identifier, the first instruction set calling an executable code of a software application system that provides an existing functionality of the software application system;
retrieve an instruction modifier, based on the modifier identifier, including a transformation instruction to carry out a transformation operation on the first instruction set, the instruction modifier comprising a second instruction set that includes different instructions calling a modifying executable code that provides a functionality, the functionality modifying the existing functionality and providing an additional functionality, wherein the transforming of the instruction set comprises at least one of adding an instruction to the instruction set, deleting an instruction from the instruction set, and modifying an instruction included in the instruction set;
retrieve execution logic that defines an execution order; and
execute an instruction from a modified instruction set based on the execution logic, the execution comprising retrieving the modifying executable code called by the different instructions and executing the modifying executable code, the executing of the modified instruction set providing the additional functionality; and
a transformation engine module configured to perform the transformation operation, the transformational operation to merge the first instruction set with the second instruction set to provide the modified instruction set.

14. The system of claim 13, wherein the transformation engine module is further configured to output log information.

15. The system of claim 14, wherein the modified instruction set includes the log information.

16. The system of claim 13, wherein the first instruction set is included in an eXtensible Markup Language (XML) file.

17. The system of claim 13, wherein the modified instruction set includes the first and second instruction sets.

18. A system comprising:
a first means for accessing an instruction set that includes instructions calling an executable code of a software application system, the executable code providing an existing functionality of the software application system;
a second means for associating an instruction modifier with the instruction set, the instruction modifier including a transformation instruction to carry out a transformation operation on the instruction set to provide an additional functionality;
a third means for transforming the instruction set into a modified instruction set based on carrying out the transformation operation on the instruction set, the modified instruction set including different instructions calling a modifying executable code that provides a functionality, the functionality modifying the existing functionality to provide the additional functionality when the modified instruction set is executed, wherein the transforming of the instruction set comprises at least one of adding an instruction to the instruction set, deleting an instruction from the instruction set, and modifying an instruction included in the instruction set; and
a fourth means for executing the modified instruction set, the means for execution comprising retrieving the modifying executable code called by the different instructions and executing the modifying executable code, the executing of the modified instruction set providing the additional functionality.

19. The system of claim 18, wherein the modification of the existing functionality includes addition of the functionality to the existing functionality.

20. The system of claim 18, wherein the modification of the existing functionality includes deleting the existing functionality.

21. The system of claim 18, wherein the modification of the existing functionality includes modifying the existing functionality.
